(19) United States
(12) Patent Application Publication
(10) Pub. No.: US 2024/0095173 A1
(43) Pub. Date: Mar. 21, 2024

(54) PROVIDING FAIRNESS-BASED ALLOCATION OF CACHES IN PROCESSOR-BASED DEVICES

(71) Applicant: QUALCOMM Incorporated, San Diego, CA (US)

(72) Inventor: Suryanarayana Murthy Durbhakula, Hyderabad (IN)

(21) Appl. No.: 17/933,232

(22) Filed: Sep. 19, 2022

(51) Int. Cl. G06F 12/0871; G06F 12/0891

(52) U.S. Cl. CPC G06F 12/0871; G06F 12/0891; G06F 2212/6042

(57) ABSTRACT

Providing fairness-based allocation of caches in processor-based devices is disclosed. In some aspects, a processor-based device comprises a processor that comprises a cache. The processor is configured to determine a fairness index for a client of a plurality of clients of the cache. The processor is further configured to allocate a portion of the cache for use by the client based on the fairness index. The processor is also configured to receive data to be written to the cache, wherein the data corresponds to the client. The processor is additionally configured to write the data to a cache line within the cache based on the portion of the cache allocated to the client.

### BACKGROUND

### I. Field of the Disclosure

The technology of the disclosure relates generally to the use of caches in processor-based devices.

### II. BACKGROUND

Processor-based devices are subject to a phenomenon known as memory access latency, which is a time interval between the time a processor initiates a memory access request (i.e., by executing a memory load instruction) for data and the time the processor actually receives the requested data. In more extreme cases, memory access latency for a memory access request may be large enough that the processor is forced to stall further execution of instructions while waiting for a memory access request to be fulfilled. Accordingly, memory access latency is considered to be one of the factors having the biggest impact on the performance of modern processor-based devices.

One approach to minimizing the effects of memory access latency is the use of cache memory, also referred to simply as “cache.” A cache is a memory device that has a smaller capacity than system memory but can be accessed faster by a processor due to the type of memory used and/or the physical location of the cache relative to the processor. As a result, the cache can be used to store copies of data retrieved from frequently accessed memory locations in the system memory (or from a higher-level cache memory) to reduce memory access latency.

However, a cache may not always be able to be utilized effectively by multiple clients (e.g., hardware functional units of a processor such as a graphics processing unit (GPU), and/or software processes being executed by a processor such as a central processing unit (CPU), as non-limiting examples). For instance, clients that perform more frequent memory access operations may end up monopolizing cache lines within the cache, causing cache lines that store data for access by other clients to be evicted sooner. Accordingly, a mechanism for ensuring a more fair allocation of cache resources among multiple clients of a cache is desirable.

### SUMMARY OF THE DISCLOSURE

Aspects disclosed in the detailed description include providing fairness-based allocation of caches in processor-based devices. Related apparatus and methods are also disclosed. In this regard, in some exemplary aspects disclosed herein, a processor-based device provides a processor that comprises a cache and a cache allocation circuit. The cache allocation circuit determines a fairness index for a client of a plurality of clients of a cache of the processor and allocates a portion of the cache for use by the client based on the fairness index. Upon receiving data that corresponds to the client and that is to be written to the cache, the cache allocation circuit then writes the data to a cache line within the cache based on the portion of the cache allocated to the client. In some aspects, the cache allocation circuit may employ a reallocation counter to ensure that allocation of the cache only occurs after multiple observation intervals indicate that reallocation is needed. Some aspects such as those in which the cache is a read/write cache may provide that, prior to allocating the portion of the cache for use by the client based on the fairness index, dirty data in one or more cache lines to be reallocated from the client is identified and flushed from the cache. According to some aspects in which the cache comprises a central processing unit (CPU) cache, the cache allocation circuit may determine that a new client (e.g., a new software process) has started, and may then initiate reallocation of the cache.

In some aspects, the fairness index for the client may comprise a ratio of a number of cache accesses to the cache that correspond to the client during an observation interval and a total number of cache accesses to the cache during the observation interval. In such aspects, allocating a portion of the cache for use by the client based on the fairness index may comprise allocating a portion of the cache for exclusive use by the client, wherein the ratio of the size of the portion of the cache to the size of the cache is the same as the fairness index for the client. Writing the data based on the portion of the cache allocated to the client in such aspects may comprise selecting a cache line within the portion of the cache allocated for exclusive use by the client. Some aspects may also track a cache hit ratio during the observation interval and may adjust the size of the portion allocated to the client based on a comparison of the hit ration to the fairness index.

According to some aspects, allocating the portion of the cache based on the fairness index may comprise determining a position within a Least Recently Used (LRU) stack of the cache based on the size of the cache and the fairness index for the client. In such aspects, writing the data based on the portion of the cache allocated to the client may comprise allocating a cache line of at the position within the LRU stack of the cache for use by the client. In some aspects, allocating the portion of the cache based on the fairness index may comprise assigning the client to a usage class of a plurality of usage classes based on the fairness index, and allocating a portion of the cache for exclusive use by the usage class. Such aspects may further provide that writing the data based on the portion of the cache allocated to the client comprises selecting a cache line within the portion of the cache allocated for exclusive use by the usage class.

In some aspects, the fairness index for the client may comprise ratio of a value of a priority indicator corresponding to the client and a total priority value of a plurality of priority indicators corresponding to the plurality of clients, and allocating the portion of the cache based on the fairness index may comprise allocating a portion of the cache for exclusive use by the client, wherein the ratio of the size of the portion of the cache to the size of the cache is the same as the fairness index for the client. Such aspects may provide that writing the data based on the portion of the cache allocated to the client comprises selecting a cache line within the portion of the cache allocated for exclusive use by the client.

In another aspect, a processor-based device is provided. The processor-based device comprises a processor that comprises a cache. The processor is configured to determine a fairness index for a client of a plurality of clients of the cache. The processor is further configured to allocate a portion of the cache for use by the client based on the fairness index. The processor is also configured to receive data to be written to the cache, wherein the data corresponds to the client. The processor is additionally configured to write the data to a cache line within the cache based on the portion of the cache allocated to the client.

In another aspect, a processor-based device is provided. The processor-based device comprises means for determining a fairness index for a client of a plurality of clients of a cache of a processor of the processor-based device. The processor-based device further comprises means for allocating a portion of the cache for use by the client based on the fairness index. The processor-based device also comprises means for receiving data to be written to the cache, wherein the data corresponds to the client. The processor-based device additionally comprises means for writing the data to a cache line within the cache based on the portion of the cache allocated to the client.

In another aspect, a method for providing fairness-based allocation of caches in processor-based devices is provided. The method comprises determining, using a cache allocation circuit of a processor of a processor-based device, a fairness index for a client of a plurality of clients of a cache of the processor. The method further comprises allocating a portion of the cache for use by the client based on the fairness index. The method also comprises receiving data to be written to the cache, wherein the data corresponds to the client. The method additionally comprises writing the data to a cache line within the cache based on the portion of the cache allocated to the client.

### BRIEF DESCRIPTION OF THE FIGURES

FIG. 1 is a block diagram of an exemplary processor-based device including a cache allocation circuit for providing fairness-based allocation of caches in processor-based devices;

FIG. 2 is a block diagram illustrating an exemplary aspect of the cache allocation circuit of FIG. 1 in which portions of a cache are allocated in proportion to the number of cache accesses for each of a plurality of clients of the cache relative to a total number of cache accesses during an observation interval;

FIG. 3 is a block diagram illustrating an exemplary aspect of the cache allocation circuit of FIG. 1 in which portions of a cache are allocated by determining a position in a Least Recently Used (LRU) stack for cache lines associated with each client of the cache;

FIG. 4 is a block diagram illustrating an exemplary aspect of the cache allocation circuit of FIG. 1 in which portions of a cache are allocated to usage classes to which clients may be assigned;

FIG. 5 is a block diagram illustrating an exemplary aspect of the cache allocation circuit of FIG. 1 in which portions of a cache are allocated in proportion to a client priority for each of a plurality of clients of the cache relative to a total of client priorities;

FIGS. 6A and 6B are flowcharts illustrating exemplary operations by the cache allocation circuit of FIG. 1 for providing fairness-based allocation of caches, according to some aspects;

FIGS. 7A and 7B are flowcharts illustrating additional exemplary operations for providing fairness-based allocation of caches by allocating portions of a cache in proportion to cache accesses for each client of the cache relative to total cache accesses during an observation interval, according to some aspects;

FIG. 8 is a flowchart illustrating additional exemplary operations for providing fairness-based allocation of caches by determining an insertion point into a LRU stack of a cache based on cache accesses for each client of the cache relative to total cache accesses during an observation interval, according to some aspects;

FIG. 9 is a flowchart illustrating additional exemplary operations for providing fairness-based allocation of caches by assigning each client of the cache to a usage class, and allocating portions of the cache to each usage class based on cache accesses during an observation interval, according to some aspects;

FIG. 10 is a flowchart illustrating additional exemplary operations for providing fairness-based allocation of caches by allocating portions of a cache in proportion to a client priority for each client of the cache relative to a total value of client priorities, according to some aspects; and

FIG. 11 is a block diagram of an exemplary processor-based device that can include the processor-based device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include providing fairness-based allocation of caches in processor-based devices. Related apparatus and methods are also disclosed. In this regard, in some exemplary aspects disclosed herein, a processor-based device provides a processor that comprises a cache and a cache allocation circuit. The cache allocation circuit determines a fairness index for a client of a plurality of clients of a cache of the processor and allocates a portion of the cache for use by the client based on the fairness index. Upon receiving data that corresponds to the client and that is to be written to the cache, the cache allocation circuit then writes the data to a cache line within the cache based on the portion of the cache allocated to the client. In some aspects, the cache allocation circuit may employ a reallocation counter to ensure that allocation of the cache only occurs after multiple observation intervals indicate that reallocation is needed. Some aspects such as those in which the cache is a read/write cache may provide that, prior to allocating the portion of the cache for use by the client based on the fairness index, dirty data in one or more cache lines to be reallocated from the client is identified and flushed from the cache. According to some aspects in which the cache comprises a central processing unit (CPU) cache, the cache allocation circuit may determine that a new client (e.g., a new software process) has started, and may then initiate reallocation of the cache.

In some aspects, the fairness index for the client may comprise a ratio of a number of cache accesses to the cache that correspond to the client during an observation interval and a total number of cache accesses to the cache during the observation interval. In such aspects, allocating a portion of the cache for use by the client based on the fairness index may comprise allocating a portion of the cache for exclusive use by the client, wherein the ratio of the size of the portion of the cache to the size of the cache is the same as the fairness index for the client. Writing the data based on the portion of the cache allocated to the client in such aspects may comprise selecting a cache line within the portion of the cache allocated for exclusive use by the client. Some aspects may also track a cache hit ratio during the observation interval and may adjust the size of the portion allocated to the client based on a comparison of the hit ration to the fairness index.

According to some aspects, allocating the portion of the cache based on the fairness index may comprise determining a position within a Least Recently Used (LRU) stack of the cache based on the size of the cache and the fairness index for the client. In such aspects, writing the data based on the portion of the cache allocated to the client may comprise allocating a cache line of at the position within the LRU stack of the cache for use by the client. In some aspects, allocating the portion of the cache based on the fairness index may comprise assigning the client to a usage class of a plurality of usage classes based on the fairness index, and allocating a portion of the cache for exclusive use by the usage class. Such aspects may further provide that writing the data based on the portion of the cache allocated to the client comprises selecting a cache line within the portion of the cache allocated for exclusive use by the usage class.

In some aspects, the fairness index for the client may comprise ratio of a value of a priority indicator corresponding to the client and a total priority value of a plurality of priority indicators corresponding to the plurality of clients, and allocating the portion of the cache based on the fairness index may comprise allocating a portion of the cache for exclusive use by the client, wherein the ratio of the size of the portion of the cache to the size of the cache is the same as the fairness index for the client. Such aspects may provide that writing the data based on the portion of the cache allocated to the client comprises selecting a cache line within the portion of the cache allocated for exclusive use by the client.

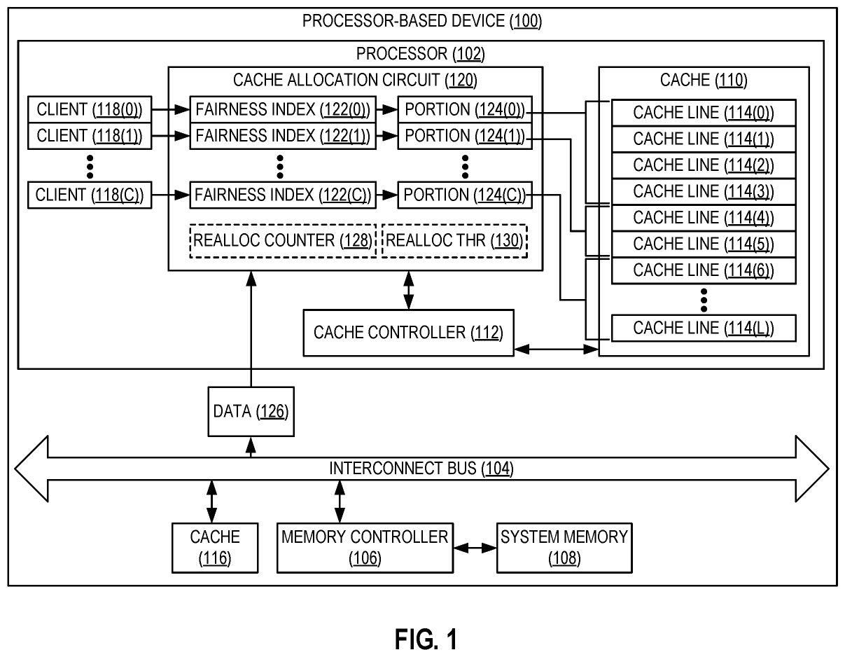

In this regard, FIG. 1 illustrates an exemplary processor-based device 100 that provides a processor 102 for providing fairness-based allocation of caches. The processor 102 in some aspects may comprise a CPU or a graphics processing unit (GPU) having one or more processor cores, and in some exemplary aspects may be one of a plurality of similarly configured processors (not shown) of the processor-based device 100. The processor 102 is communicatively coupled to an interconnect bus 104, which in some embodiments may include additional constituent elements (e.g., a bus controller circuit and/or an arbitration circuit, as non-limiting examples) that are not shown in FIG. 1 for the sake of clarity. The processor 102 is also communicatively coupled, via the interconnect bus 104, to a memory controller 106 that controls access to a system memory 108 and manages the flow of data to and from the system memory 108. The system memory 108 provides addressable memory used for data storage by the processor-based device 100, and as such may comprise synchronous dynamic random access memory (SDRAM), as a non-limiting example.

The processor 102 of FIG. 1 further includes a cache 110 that is communicatively coupled to a cache controller 112, and that may be used to cache local copies of frequently accessed data within the processor 102 for quicker access (e.g., by a memory access stage of an execution pipeline (not shown) of the processor 102). The cache 110 provides a plurality of cache lines 114(0)-114(L) for storing frequently accessed data retrieved from the system memory 108. The cache lines 114(0)-114(L) comprise tags (not shown), each of which store information that enables the corresponding cache lines 114(0)-114(L) to be mapped to unique memory addresses, and further comprise data (not shown) in which the actual data retrieved from the system memory 108 or from a higher-level cache is stored. It is to be understood that the cache lines 114(0)-114(L) may include other data elements, such as validity indicators and/or dirty data indicators, that are also not shown in FIG. 1 for the sake of clarity. The cache lines 114(0)-114(L) may be organized into one or more sets (not shown) that each comprise one or more ways (not shown), and the cache 110 may be configured to support a corresponding level of associativity.

The processor 102 in the example of FIG. 1 is also communicatively coupled, via the interconnect bus 104, to a cache 116, which may comprise, e.g., a Level 2 (L2) cache, a Level 3 (L3) cache, or a unified cache (UCHE). The cache 110 and the cache 116 together make up a hierarchical cache structure used by the processor-based device 100 to cache frequently accessed data for faster retrieval (compared to retrieving data from the system memory 108).

The processor 102 includes a plurality of clients 118(0)-118(C), each of which may retrieve data from the cache 116 and/or the system memory 108 to be cached in the cache 110. The clients 118(0)-118(C) in some aspects (e.g., those in which the processor 102 comprises a GPU) may comprise hardware functional units such as a shader processor, a texture processor, and/or a vertex fetch and decode processor, as non-limiting examples. In such aspects, the number C of clients 118(0)-118(C) may be a fixed value that remains unchanged while the processor 102 is in operation. Some aspects, such as those in which the processor 102 is a CPU, may provide that the clients 118(0)-118(C) comprise software processes being executed by the processor 102. Consequently, in such aspects, the number C of clients 118(0)-118(C) may vary over time as processes complete execution and are terminated, or as new processes are launched.

The processor-based device 100 of FIG. 1 may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include more or fewer elements than illustrated in FIG. 1. For example, the processor 102 may further include more or fewer memory devices execution pipeline stages, controller circuits, buffers, and/or caches, which are omitted from FIG. 1 for the sake of clarity.

As noted above, it may be possible for one or more of the clients 118(0)-118(C) to monopolize the cache 110 to the detriment of other clients. For example, if the client 118(0) performs memory access operations more frequently than the client 118(1) and the client 118(C), data cached in the cache 110 for the client 118(0) may displace data cached in the cache 110 for the client 118(1) and the client 118(C), depriving the client 118(1) and 118(C) of the benefits of using the cache 110. Accordingly, in this regard, the processor 102 provides a cache allocation circuit 120 to ensure fairness-based allocation of the cache 110. As used herein, a “fairness-based allocation” of the cache 110 refers to allocating the cache 110 to the clients 118(0)-118(C) in such a manner that the likelihood of one of the clients 118(0)-118(C) monopolizing the entire cache 110 is reduced or eliminated. It is to be understood that, while the cache allocation circuit 120 is illustrated in FIG. 1 as a separate element, in some aspects the cache allocation circuit 120 may be integrated in whole or in part into other elements of the processor 102, such as the cache controller 112.

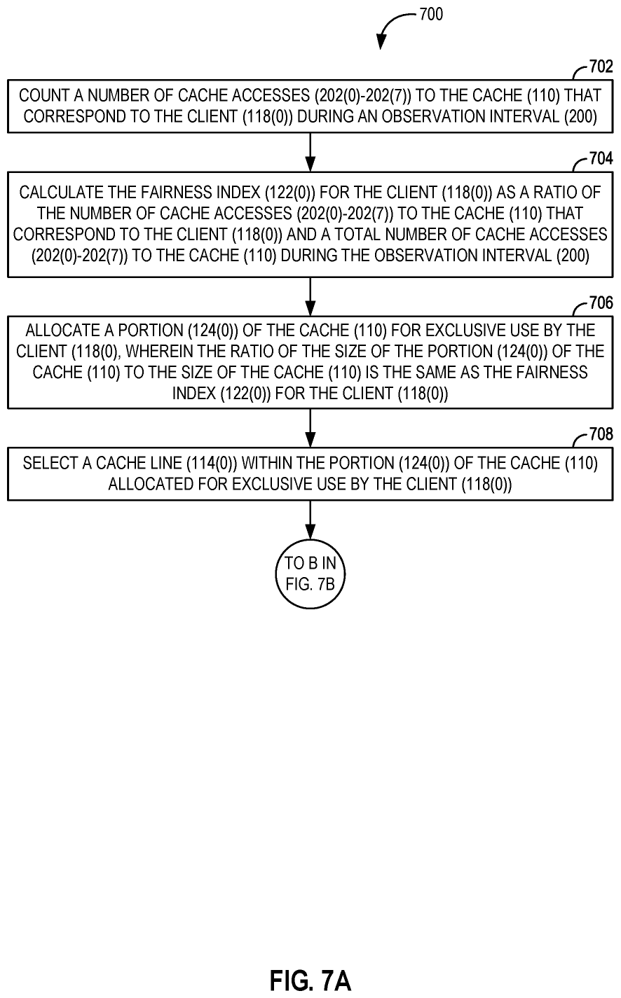

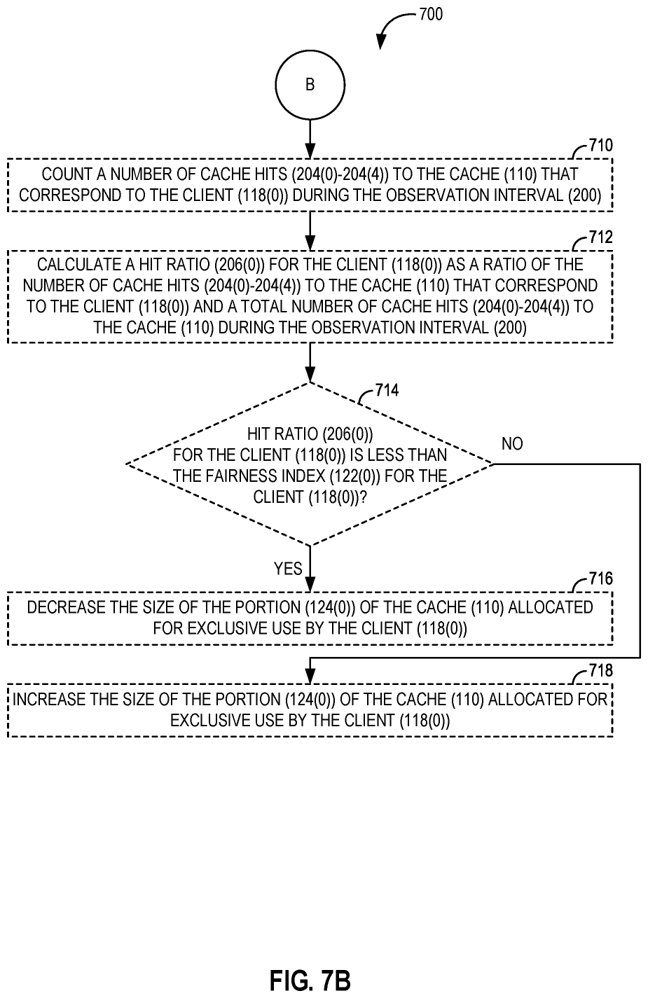

In exemplary operation, the cache allocation circuit 120 determines, for each of the plurality of clients 118(0)-118(C), a corresponding fairness index 122(0)-122(C) that is used to determine allocation of the cache 110 for that client. After determining the fairness indices 122(0)-122(C), the cache allocation circuit 120 allocates corresponding portions 124(0)-124(C) of the cache 110 to the clients 118(0)-118(C) based on the fairness indices 122(0)-122(C). When the processor 102 subsequently receives data 126, corresponding to a client, to be written to the cache 110, the cache allocation circuit 120 writes the data 126 to a cache line within the cache 110 based on the portion of the cache 110 allocated to the client. For example, the portion 124(0) in FIG. 1 corresponding to the client 118(0) indicates that the cache lines 114(0)-114(3) are allocated to the client 118(0). Thus, if the data 126 corresponds to the client 118(0), the cache allocation circuit 120 will write the data 126 to one of the cache lines 114(0)-114(3) as indicated by the portion 124(0). Exemplary operations for determining the fairness indices 122(0)-122(C), as well as exemplary operations for allocating the portions 124(0)-124(C) of the cache 110 based on the fairness indices 122(0)-122(C) and writing the data 126 based on the portions 124(0)-124(C) of the cache 110 allocated to the clients 118(0)-118(C), are discussed in greater detail below with respect to FIGS. 7A and 7B, 8, 9, and 10.

According to some aspects, the fairness indices 122(0)-122(C) may be calculated based on, e.g., cache accesses and/or cache hits for corresponding clients 118(0)-118(C) that occur during an observation interval (e.g., over a specified number of cache accesses to the cache 110). Some such aspects may provide that the allocation of the cache 110 for a given client (e.g., the client 118(0)) may be modified only if the fairness index 122(0) for the client 118(0) indicates a change over multiple observation intervals. Accordingly, in such aspects, the cache allocation circuit 120 may determine whether the fairness index 122(0) indicates that reallocation of the cache 110 is necessary. This may be accomplished by tracking earlier values of the fairness index 122(0) and comparing the earlier values to more recently calculated values to see if the earlier values and the more recently calculated values diverge. If so, the cache allocation circuit 120 may increment a reallocation counter (captioned as “REALLOC COUNTER” in FIG. 1) 128 and compare the reallocation counter 128 to a reallocation threshold (captioned as “REALLOC THR” in FIG. 1) 130. The cache allocation circuit 120 may then reallocate the cache 110 only if the reallocation counter 128 exceeds the reallocation threshold 130.

In aspects in which the cache 110 is a read/write cache, one or more of the cache lines 114(0)-114(L) may store “dirty” data, or data that was modified after being stored in the cache 110. In such aspects, when the cache allocation circuit 120 determines the portions 124(0)-124(C) based on the fairness indices 122(0)-122(C), the cache allocation circuit 120 identifies dirty data in one or more cache lines to be reallocated from one of the clients 118(0)-118(C) to another, and flushes the dirty data from the cache line (e.g., by writing the dirty data to the cache 116 or the system memory 108, and then invalidating the cache line 114(0)). Thus, for instance, if the cache allocation circuit 120 determines that the cache line 114(3) will be reallocated from the client 118(0) to the client 118(1) and contains dirty data, the cache allocation circuit 120 is configured to flush the dirty data from the cache line 114(3) before reallocating the cache line 114(3) to the client 118(1).

As noted above, in aspects in which the cache 110 comprises a CPU cache, the plurality of clients 118(0)-118(C) may comprises a variable number of executing processes. In such aspects, the cache allocation circuit 120 is configured to determine when a new client has started (e.g., by querying and/or receiving an indication (not shown) from a task manager (not shown) or other element of the processor 102). In response to determining that a new client has started, the cache allocation circuit 120 initiates reallocation of the cache 110. In this manner, the cache allocation circuit 120 can ensure that new clients receive an appropriate allocation of the cache 110.

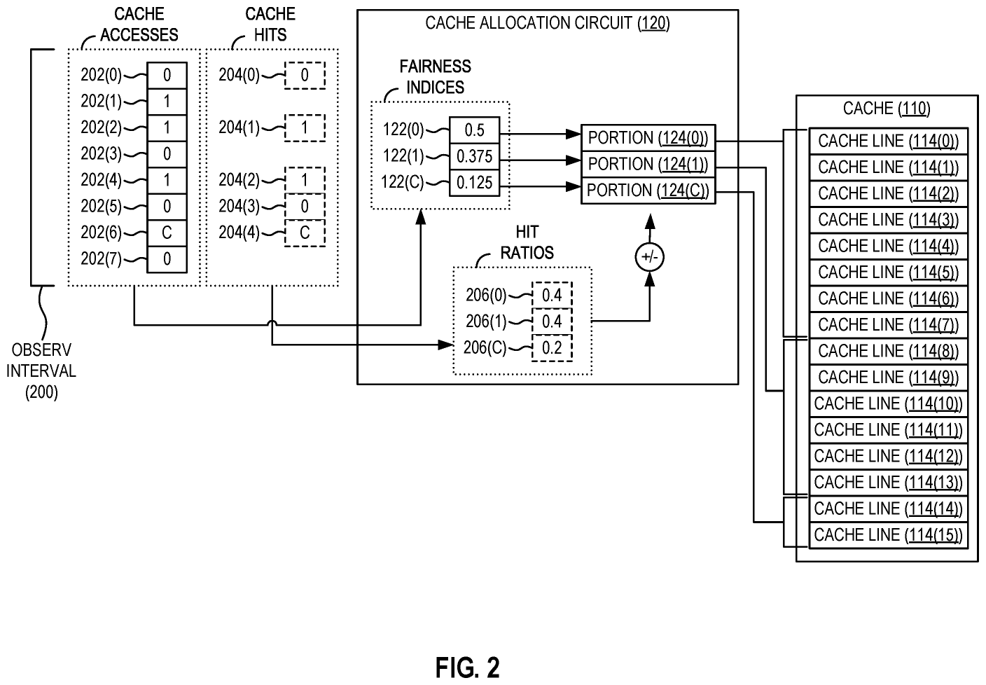

In some aspects of the processor 102 of FIG. 1, the portions 124(0)-124(C) of the cache 110 are allocated in proportion to the number of cache accesses for each of the clients 118(0)-118(C) relative to a total number of cache accesses during an observation interval. In this regard, FIG. 2 illustrates an observation interval (captioned as “OBSERV INTERVAL” in FIG. 2) 200, during which multiple cache accesses 202(0)-202(7) for different ones of the clients 118(0)-118(C) of FIG. 1 are detected and counted by some aspects of the cache allocation circuit 120 of FIG. 1 (e.g., by monitoring incoming cache access requests to the cache controller 112 of FIG. 1, or by receiving notifications from the cache controller 112 of FIG. 1). Each of the cache accesses 202(0)-202(7) corresponds to one of the client 118(0), the client 118(1), and the client 118(C) of FIG. 1, and is captioned accordingly in FIG. 2. The observation interval 200 in FIG. 2 comprises a time interval during which the cache accesses 202(0)-202(7) are observed by the cache allocation circuit 120 and may be configurable by software (such as a driver) as a specific time interval or as a specific number of cache accesses. In aspects in which the observation interval 200 is a driver-configurable time interval, the total number of cache access 202(0)-202(7) to the cache 110 may be based both on the observation interval 200 and on one or more workloads (not shown) that may be executing on the processor-based device 100.

In the example of FIG. 2, the cache allocation circuit 120 counts the number of the cache accesses 202(0)-202(7) to the cache 110 that corresponds to each client during the observation interval 200. The cache allocation circuit 120 then calculates each of the fairness indices 122(0)-122(C) (corresponding to the client 118(0), the client 118(1), and the client 118(C), respectively) as a ratio of the number of cache accesses to the cache 110 that correspond to the respective client and a total number of cache accesses to the cache 110 during the observation interval 200. In this example, the total number of cache accesses 202(0)-202(7) is eight (8), with the client 118(0) being associated with four (4) cache accesses 202(0), 202(3), 202(5) and 202(7); the client 118(1) being associated with three (3) cache accesses 202(1), 202(2), and 202(4); and the client 118(C) being associated with one (1) cache access 202(6). Thus, the fairness index 122(0) associated with the client 118(0) is calculated as 4/8 or 0.5, the fairness index 122(1) associated with the client 118(1) is calculated as ⅜ or 0.375, and the fairness index 122(C) associated with the client 118(C) is calculated as ⅛ or 0.125.

The cache allocation circuit 120 then allocates the portions 124(0)-124(C) so that the ratio of the size of each portion 124(0)-124(C) to the size of the cache 110 is the same as the respective fairness index 122(0)-122(C) for the corresponding client. The portions 124(0)-124(C) each may specify a number of cache lines 114(0)-114(15) allocated to the corresponding client, or may specify, e.g., a number of ways of the cache 110 allocated to the corresponding client or a percentage of the associativity of the cache 110 allocated to the corresponding client. In the example of FIG. 2, the cache 110 contains 16 cache lines 114(0)-114(15). Thus, in FIG. 2, the portion 124(0) corresponds to eight (8) cache lines 114(0)-114(7), the portion 124(1) corresponds to six (6) cache lines 114(8)-114(13), and the portion 124(C) corresponds to two (2) cache lines 114(14)-114(15). Note that the cache allocation circuit 120 is configured to ensure that each of the clients is allocated at least one (1) of the cache lines 114(0)-114(15) at a minimum.

The client 118(0), the client 118(1), and the client 118(C) are then granted exclusive access to the corresponding portions 124(0)-124(C) of the cache 110 by the cache allocation circuit 120. Accordingly, when writing data corresponding to a client to the cache 110, the cache allocation circuit 120 ensures that a cache line within the portion allocated to the client is selected to store the data. For instance, for data associated with the client 118(0), the cache allocation circuit 120 will select a cache line, such as the cache line 114(0), from among the cache lines 114(0)-114(7) to store the data.

In some aspects, the size of the portions 124(0)-124(C) may be further refined based on a number of cache hits counted by the cache allocation circuit 120 during the observation interval 200. In the example of FIG. 2, the cache allocation circuit 120 counts a total of five (5) cache hits 204(0)-204(4) during the observation interval 200: two (2) cache hits 204(0) and 204(3) for the client 118(0); two (2) cache hits 204(1) and 204(2) for the client 118(1); and one (1) cache hit 204(4) for the client 118(C). The cache allocation circuit 120 then calculate hit ratios 206(0)-206(C) for the clients, wherein each of the hit ratios 206(0)-206(C) is a ratio of the number of cache hits to the cache 110 that correspond to the respective client and a total number of cache hits to the cache 110 during the observation interval 200. In the example of FIG. 2, the hit ratio 206(0) associated with the client 118(0) is calculated as ⅖ or 0.4, the hit ratio 206(1) for the client 118(1) is calculated as ⅖ or 0.4, and the hit ratio 206(C) for the client 118(C) is calculated as ⅕ or 0.2.

The cache allocation circuit 120 then determines whether each of the hit ratios 206(0)-206(C) is less than the corresponding fairness index 122(0)-122(C). If so, the cache allocation circuit 120 can conclude that the corresponding client is not making efficient use of its allocated portion 124(0)-124(C) of the cache 110 and decrease the size of the corresponding portion 124(0)-124(C) of the cache 110 allocated for exclusive use by that client. However, if a client's hit ratio 206(0)-206(C) is not less than the corresponding fairness index 122(0)-122(C), the cache allocation circuit 120 may increase the size of the corresponding portion 124(0)-124(C) of the cache 110 allocated for exclusive use by that client. Accordingly, in FIG. 2, the cache allocation circuit 120 may decrease the size of the portion 124(0) for client 118(0), and may increase the size of the portion 124(1) for client 118(1) and the portion 124(C) for client 118(C).

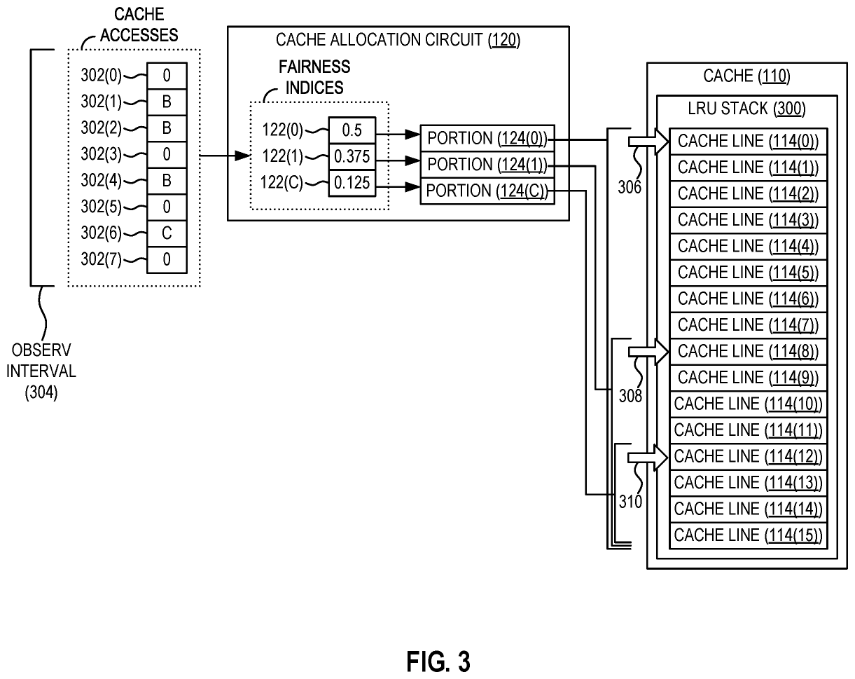

FIG. 3 illustrates another aspect of the cache allocation circuit 120 of FIG. 1 in which each fairness index 122(0)-122(C) is based on a number of cache accesses for each client of the cache relative to total cache accesses during an observation interval and is used to allocate the cache 110 by determining a position in an LRU stack for cache lines associated with the respective client. As seen in FIG. 3, the cache 110 includes the cache lines 114(0)-114(15) that are logically organized as an LRU stack 300, such that the most recently accessed cache line is stored as the cache line 114(0) and the least recently used cache line is stored as the cache line 114(15). It is to be understood that the actual implementation of the cache 110 may implement the LRU stack 300 using additional data structures not shown in FIG. 3 for the sake of clarity. For example, the LRU stack 300 may be implemented as a doubly linked list, and the cache lines 114(0)-114(15) may be implemented as a separate hash map that links to nodes in the doubly linked list of the LRU stack 300.

In FIG. 3, the fairness indices 122(0)-122(C) are determined as discussed above with respect to FIG. 2, with the cache allocation circuit 120 counting the number of cache accesses 302(0)-302(7) to the cache 110 that corresponds to each client 118(0)-118(C) during an observation interval (captioned as “OBSERV INTERVAL” in FIG. 3) 304, and then calculating each of the fairness indices 122(0)-122(C) as a ratio of the number of cache accesses to the cache 110 that correspond to the respective client and a total number of cache accesses to the cache 110 during the observation interval 304. The cache allocation circuit 120 then determines, for the clients 118(0)-118(C), the portions 124(0)-124(C) as indicating corresponding positions 306, 308, and 310 within the LRU stack 300 of the cache 110, based on the size of the cache 110 and the corresponding fairness indices 122(0)-122(C). For instance, in the example of FIG. 3, the cache allocation circuit 120 is configured to associate the position 306 with the client having the highest fairness index, the position 308 with the client having the next highest fairness index, and the position 310 with the client having the lowest fairness index. Thus, the portion 124(0) of the client 118(0) indicates the position 306, the portion 124(1) of the client 118(1) indicates the position 308, and the portion 124(C) of the client 118(C) indicates the position 310.

Subsequently, when writing data corresponding to a client to the cache 110, the cache allocation circuit 120 allocates a cache line at the position in the LRU stack 300 associated with the client. For example, for data associated with the client 118(0), the cache allocation circuit 120 will allocate a cache line at the position 306 in the LRU stack 300 (i.e., the cache line 114(0) in FIG. 3) to store the data. The LRU stack 300 thus will handle the allocated cache line 114(0) as if it were the most recently added cache line, which increases the likelihood that the allocated cache line 114(0) will remain in the cache 110 for a longer period of time. In contrast, data associated with the client 118(C) will be allocated a cache line at the position 310 of the LRU stack 300 (i.e., the cache line 114(15) in FIG. 3), which will be more likely to be evicted sooner from the cache 110 than the cache line 114(0) at the position 306.

Note, however, that some aspects may provide that a cache line belonging to any one of the clients 118(0)-118(C) will be moved to the position 306 at the top of the LRU stack 300 in response to a hit on the cache line, irrespective of the corresponding fairness index 122(0)-122(C) for that client. This helps to balance the good locality of cache lines for each client 118(0)-118(C) with the fairness index 122(0)-122(C) for each client 118(0)-118(C). As a result, the areas of the cache 110 represented by the portions 124(0)-124(C) do not indicate cache lines that can be exclusively accessed by each of the clients 118(0)-118(C), but rather indicate the regions of the cache 110 that are most likely to contain cache lines corresponding to each of the clients 118(0)-118(C). It is to be further understood that the positions 306, 308, and 310 may be statically assigned by the cache allocation circuit 120, or may be dynamically determined based on, e.g., the value of the fairness indices 122(0)-122(C) applied to the size of the cache 110, or on another heuristic or set of rules.

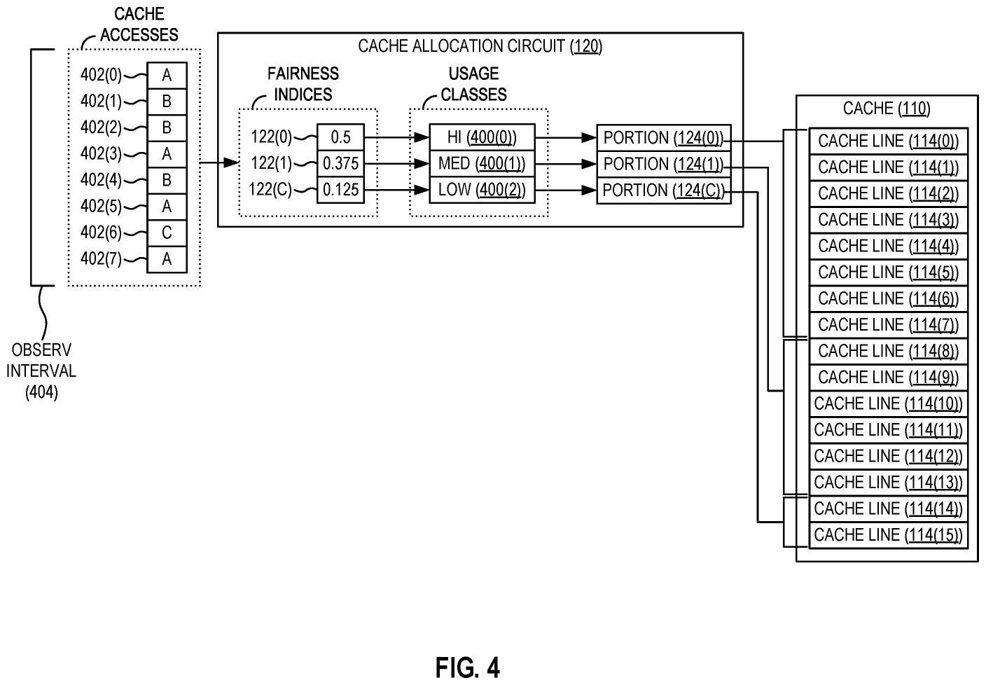

In FIG. 4, another aspect of the cache allocation circuit 120 of FIG. 1 is illustrated in which each fairness index 122(0)-122(C) is based on a number of cache accesses for each client of the cache relative to total cache accesses during an observation interval and is used to assign clients to usage classes that are allocated portions of the cache 110. As seen in FIG. 4, the cache allocation circuit 120 provides three (3) usages classes: a high-usage class (captioned as “HI” in FIG. 4) 400(0), a medium-usage class (captioned as “MED” in FIG. 4) 400(1), and a low-usage class (captioned as “LOW” in FIG. 4) 400(2). It is to be understood that some aspects may provide more or fewer usage classes than the three (3) usage classes 400(0)-400(2) shown in FIG. 4. The fairness indices 122(0)-122(C) in the example of FIG. 4 are determined as discussed above with respect to FIGS. 2 and 3, with the cache allocation circuit 120 counting the number of cache accesses 402(0)-402(7) to the cache 110 that corresponds to each client 118(0)-118(C) during an observation interval (captioned as “OBSERV INTERVAL” in FIG. 4) 404, and then calculating each of the fairness indices 122(0)-122(C) as a ratio of the number of cache accesses to the cache 110 that correspond to the respective client and a total number of cache accesses to the cache 110 during the observation interval 404.

The cache allocation circuit 120 next assigns each of the clients 118(0)-118(C) to one of the usage classes 400(0)-400(2) based on the corresponding fairness indices 122(0)-122(C) (e.g., by comparing the fairness indices 122(0)-122(C) to thresholds (not shown) for each of the usage classes 400(0)-400(2)). In FIG. 4, the client 118(0) associated with the fairness index 122(0) is assigned to the usage class 400(0), while the client 118(1) associated with the fairness index 122(1) is assigned to the usage class 400(1), and the client 118(C) associated with the fairness index 122(C) is assigned to the usage class 400(2). The cache allocation circuit 120 then allocates the portions 124(0)-124(C) for exclusive use by corresponding usage classes 400(0)-400(2). Thus, in the example of FIG. 4, the usage class 400(0) is allocated the portion 124(0) corresponding to the cache lines 114(0)-114(7) of the cache 110, the usage class 400(1) is allocated the portion 124(1) corresponding to the cache lines 114(8)-114(13) of the cache 110, and the usage class 400(2) is allocated the portion 124(C) corresponding to the cache lines 114(14)-114(15).

Subsequently, when writing data corresponding to a client to the cache 110, the cache allocation circuit 120 allocates a cache line from the portion of the cache 110 associated with the usage class to which the client was assigned. For example, for data associated with the client 118(C), the cache allocation circuit 120 will allocate a cache line from the portion 124(C) corresponding to the usage class 400(2) to store the data. It is to be understood that multiple clients may be assigned to a single usage class, and thus each of the portions 124(0)-124(C) of the cache 110 may be shared by multiple clients. It is to be further understood that the allocation of the cache 110 by the portions 124(0)-124(C) shown in FIG. 4 is for illustrative purposes only, and that the cache 110 may be allocated differently for different usage classes depending on the needs of a particular implementation.

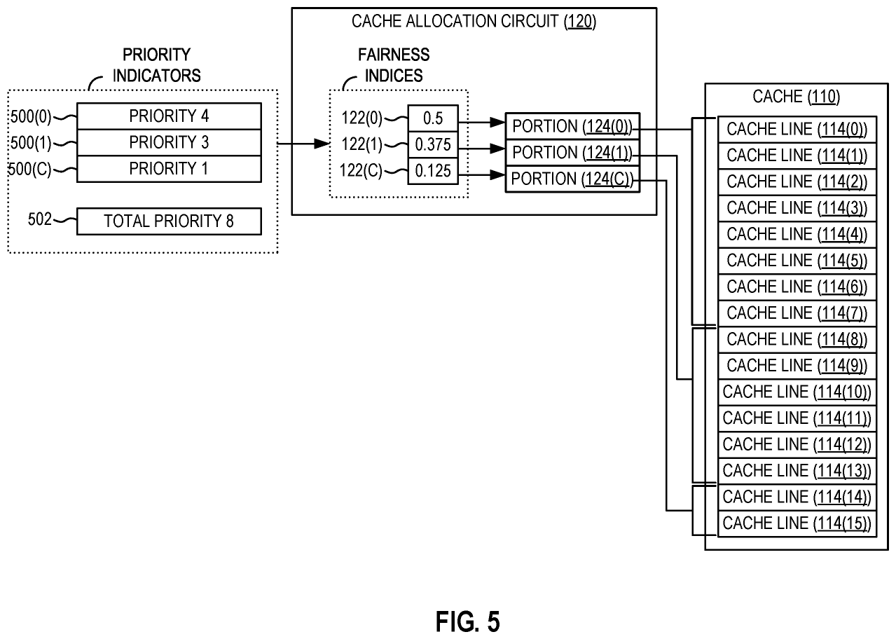

FIG. 5 illustrates another aspect of the cache allocation circuit 120 of FIG. 1 in which the cache 110 is allocated in proportion to a client priority for each of the clients 118(0)-118(C) of the cache relative to a total value of client priorities. Thus, as seen in FIG. 5, the fairness indices 122(0)-122(C) are determined according to priority indicators 500(0)-500(C) that correspond to the clients 118(0)-118(C). The priority indicators 500(0)-500(C) may represent priority values assigned to the clients 118(0)-118(C) by the processor 102 to indicate execution priority, as a non-limiting example. In FIG. 5, the priority indicator 500(0) associated with the client 118(0) has a value of four (4), the priority indicator 500(1) associated with the client 118(1) has a value of three (3), and the priority indicator 500(C) associated with the client 118(C) has a value of one (1), for a total priority value 502 of eight (8). The cache allocation circuit 120 in FIG. 5 calculates each of the fairness indices 122(0)-122(C) as a ratio of a value of the corresponding priority indicator 500(0)-500(C) and the total priority value 502. Thus, the fairness index 122(0) associated with the client 118(0) is calculated as 4/8 or 0.5, the fairness index 122(1) associated with the client 118(1) is calculated as ⅜ or 0.375, and the fairness index 122(C) associated with the client 118(C) is calculated as ⅛ or 0.125.

The cache allocation circuit 120 then allocates the portions 124(0)-124(C) so that the ratio of the size of each portion 124(0)-124(C) to the size of the cache 110 is the same as the respective fairness index 122(0)-122(C) for the corresponding client. Thus, in FIG. 5, the portion 124(0) corresponds to eight (8) cache lines 114(0)-114(7), the portion 124(1) corresponds to six (6) cache lines 114(8)-114(13), and the portion 124(C) corresponds to two (2) cache lines 114(14)-114(15). Note that the cache allocation circuit 120 is configured to ensure that each of the clients is allocated at least one (1) of the cache lines 114(0)-114(15) at a minimum.

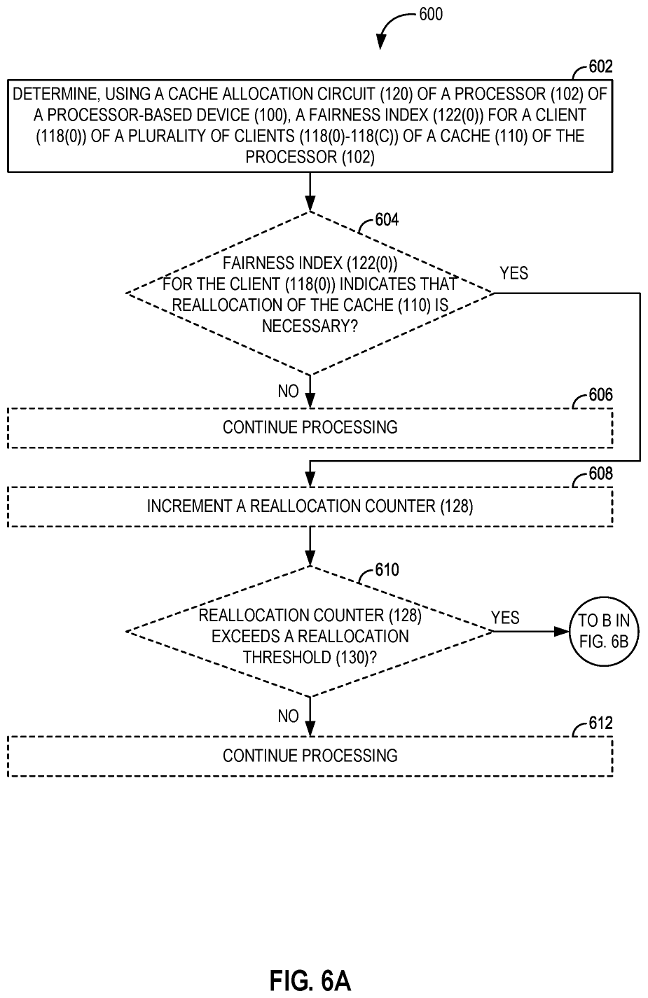

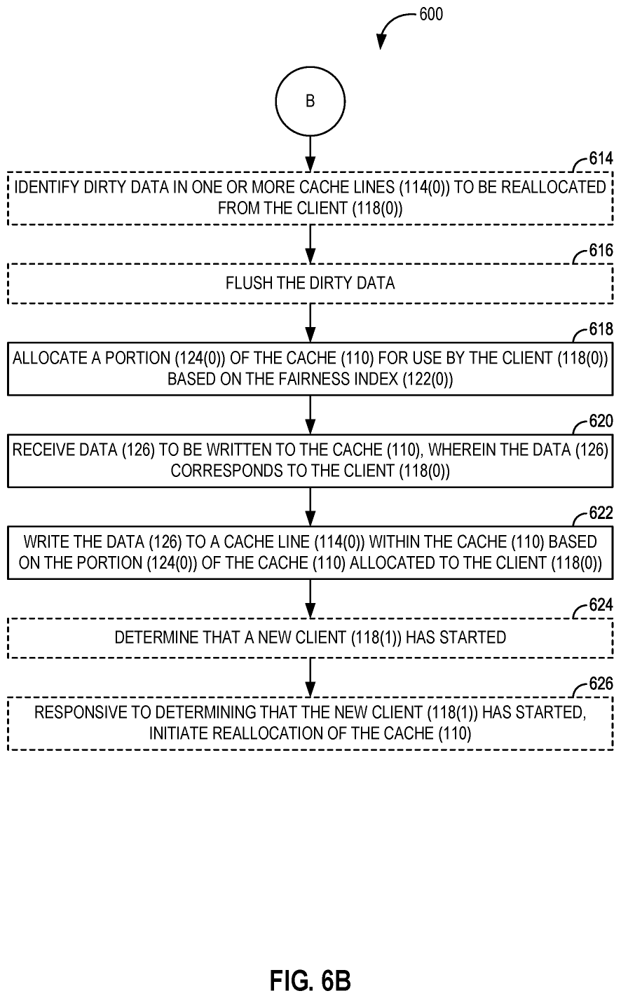

To further describe operations of the processor-based device 100 of FIG. 1 for providing fairness-based allocation of caches, FIGS. 6A and 6B provide a flowchart illustrating exemplary operations 600. For the sake of clarity, elements of FIGS. 1-5 are referenced in describing FIGS. 6A and 6B. It is to be understood that some aspects may provide that some operations illustrated in FIGS. 6A and 6B may be performed in an order other than that illustrated herein and/or may be omitted. In FIG. 6A, the operations 600 begin with the processor 102 of FIG. 1 (e.g., using the cache allocation circuit 120 of FIG. 1) determining a fairness index, such as the fairness index 122(0) of FIG. 1, for a client of a plurality of clients (e.g., the client 118(0) of the plurality of clients 118(0)-118(C) of FIG. 1) of a cache (e.g., the cache 110 of FIG. 1) of the processor 102 (block 602).

As discussed above, in some aspects, it may be desirable for the cache allocation circuit 120 to change an allocation of the cache 110, for example, only if the fairness index 122(0) for the client 118(0) indicates a change over multiple observation intervals. Accordingly, in such aspects, the cache allocation circuit 120 may determine whether the fairness index 122(0) for the client 118(0) indicates that reallocation of the cache 110 is necessary (block 604). If not, the processor 102 continues conventional processing (block 606). However, if the cache allocation circuit 120 determines at decision block 604 that the fairness index 122(0) indicates that reallocation of the cache 110 is necessary, the cache allocation circuit 120 increments a reallocation counter, such as the reallocation counter 128 of FIG. 1 (block 608). The cache allocation circuit 120 then determines whether the reallocation counter 128 exceeds a reallocation threshold, such as the reallocation threshold 130 of FIG. 1 (block 610). If not, the processor 102 continues conventional processing (block 612). If it is determined at decision block 610 that the reallocation counter 128 exceeds the reallocation threshold 130, the operations 600 continue at block 614 of FIG. 6B.

Referring now to FIG. 6B, the operations 600 continue in some aspects (e.g., aspects in which the cache 110 is a read/write cache) with the cache allocation circuit 120 identifying dirty data in one or more cache lines, such as the cache line 114(0) of FIG. 1, to be reallocated from the client 118(0) (block 614). The cache allocation circuit 120 in such allocations flushes the dirty data (e.g., by writing the dirty data to the cache 116 or the system memory 108 of FIG. 1, and then invalidating the cache line 114(0)) (block 616). The cache allocation circuit 120 then allocates a portion (e.g., the portion 124(0) of FIG. 1) of the cache 110 for use by the client 118(0) based on the fairness index 122(0) (block 618). The processor 102 subsequently receives data, such as the data 126, to be written to the cache 110, wherein the data 126 corresponds to the client 118(0) (block 620). The processor 102 then writes the data 126 to a cache line (e.g., the cache line 114(0) of FIG. 1) within the cache 110 based on the portion 124(0) of the cache 110 allocated to the client 118(0) (block 622). Exemplary operations corresponding to block 602 of FIG. 6A for determining the fairness index 122(0), as well as exemplary operations corresponding to block 618 of FIG. 6B for allocating the portion 124(0) of the cache 110 based on the fairness index 122(0) and to block 622 of FIG. 6B for writing the data 126 based on the portion 124(0) of the cache 110 allocated to the client 118(0), are discussed in greater detail below with respect to FIGS. 7A and 7B, 8, 9, and 10.

In aspects discussed above in which the cache 110 comprises a CPU cache (and thus the plurality of clients 118(0)-118(C) comprises a variable number of executing processes), the cache allocation circuit 120 may subsequently determine that a new client (e.g., the client 118(1) of FIG. 1) has started (block 624). In response, the cache allocation circuit 120 in such aspects may initiate reallocation of the cache 110 (block 626). The operations of block 626 in some aspects may comprise the cache allocation circuit 120 causing the operations of block 602-618 to be repeated anew.

FIGS. 7A and 7B provide flowcharts to illustrate additional exemplary operations 700 for providing fairness-based allocation of caches by allocating portions of a cache in proportion to cache accesses for each client of the cache relative to total cache accesses during an observation interval, according to some aspects. Elements of FIGS. 1 and 2 are referenced in describing FIGS. 7A and 7B for the sake of clarity. It is to be understood that, in some aspects, some operations illustrated in FIGS. 7A and 7B may be performed in an order other than that illustrated here and/or may be omitted. The operations 700 begin in FIG. 7A with the processor 102 of FIG. 1 (e.g., using the cache allocation circuit 120 of FIG. 1) counting a number of cache accesses, such as the cache accesses 202(0)-202(7) of FIG. 2, to a cache (e.g., the cache 110 of FIG. 1) that correspond to a client, such as the client 118(0) of FIG. 1, during an observation interval (e.g., the observation interval 200 of FIG. 2) (block 702). The cache allocation circuit 120 next calculates a fairness index (e.g., the fairness index 122(0) of FIG. 1) for the client 118(0) as a ratio of the number of cache accesses 202(0)-202(7) to the cache 110 that correspond to the client 118(0) and a total number of cache accesses 202(0)-202(7) to the cache 110 during the observation interval 200 (block 704). The operations of blocks 702 and 704 thus correspond to the operations of block 602 of FIG. 6A for determining the fairness index 122(0) for the client 118(0).

The cache allocation circuit 120 allocates a portion (e.g., the portion 124(0) of FIG. 1) of the cache 110 for exclusive use by the client 118(0), wherein the ratio of the size of the portion 124(0) of the cache 110 to the size of the cache 110 is the same as the fairness index 122(0) for the client 118(0) (block 706). In this manner, the operations of block 706 corresponds to the operations of block 618 of FIG. 6B for allocating the portion 124(0) of the cache 110 based on the fairness index 122(0). The cache allocation circuit 120 then selects a cache line, such as the cache line 114(0) of FIG. 1, within the portion 124(0) of the cache 110 allocated for exclusive use by the client 118(0) (block 708). Accordingly, the operations of block 708 may be performed as part of the operations of block 622 of FIG. 6B for writing the data 126 based on the portion 124(0) of the cache 110 allocated to the client 118(0). The operations 700 in some aspects may continue at block 710 of FIG. 7B.

Turning now to FIG. 7B, the operations 700 continue in some aspects with the cache allocation circuit 120 counting a number of cache hits (e.g., the cache hits 204(0)-204(4) of FIG. 2) to the cache 110 that correspond to the client 118(0) during the observation interval 200 (block 710). The cache allocation circuit 120 calculates a hit ratio, such as the hit ratio 206(0) of FIG. 2, for the client 118(0) as a ratio of the number of cache hits 204(0)-204(4) to the cache 110 that correspond to the client 118(0) and a total number of cache hits 204(0)-204(4) to the cache 110 during the observation interval 200 (block 712). The cache allocation circuit 120 then determines whether the hit ratio 206(0) for the client 118(0) is less than the fairness index 122(0) for the client 118(0) (block 714). If so, it can be assumed that the client 118(0) is not making efficient use of its allocation portion 124(0) of the cache 110, and so the cache allocation circuit 120 decreases the size of the portion 124(0) of the cache 110 allocated for exclusive use by the client 118(0) (block 716). However, if the cache allocation circuit 120 determines at decision block 714 that the hit ratio 206(0) for the client 118(0) is not less than the fairness index 122(0) for the client 118(0), the cache allocation circuit 120 may increase the size of the portion 124(0) of the cache 110 allocated for exclusive use by the client 118(0) (block 718).

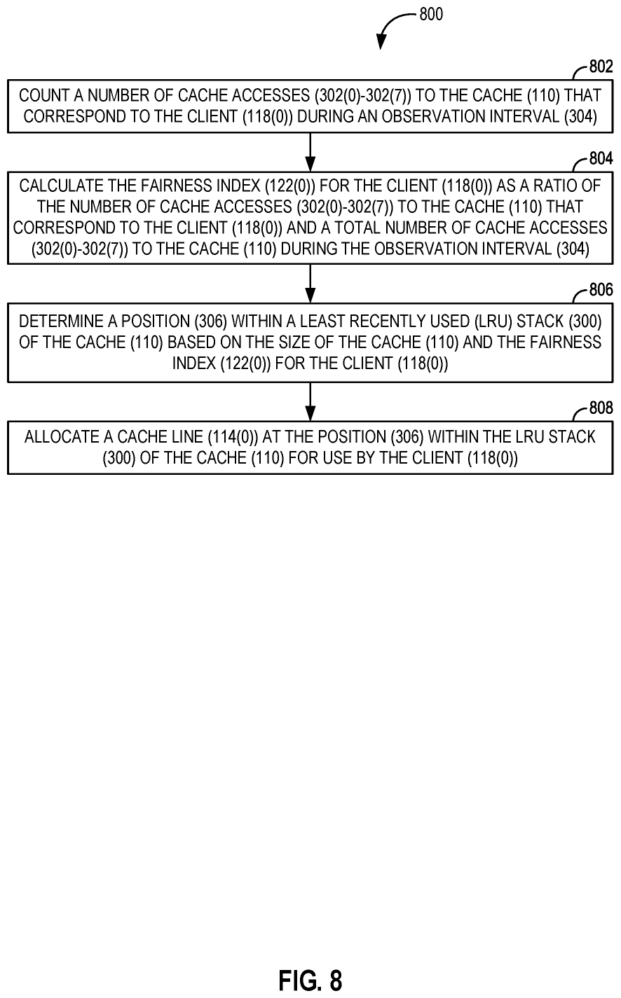

To describe operations for providing fairness-based allocation of caches by determining an insertion point into an LRU stack of a cache based on cache accesses for each client of the cache relative to total cache accesses during an observation interval according to some aspects, FIG. 8 provides a flowchart showing exemplary operations 800. Elements of FIGS. 1 and 3 are referenced in describing FIG. 8 for the sake of clarity. The operations 800 in FIG. 8 begin with the processor 102 of FIG. 1 (e.g., using the cache allocation circuit 120 of FIG. 1) counting a number of cache accesses, such as the cache accesses 302(0)-302(7) of FIG. 3, to a cache (e.g., the cache 110 of FIG. 1) that correspond to a client (e.g., the client 118(0) of FIG. 1) during an observation interval (e.g., the observation interval 304 of FIG. 3) (block 802). The cache allocation circuit 120 then calculates a fairness index (e.g., the fairness index 122(0) of FIG. 1) for the client 118(0) as a ratio of the number of cache accesses 302(0)-302(7) to the cache 110 that correspond to the client 118(0) and a total number of cache accesses 302(0)-302(7) to the cache 110 during the observation interval 304 (block 804). The operations of blocks 802 and 804 thus correspond to the operations of block 602 of FIG. 6A for determining the fairness index 122(0) for the client 118(0).

The cache allocation circuit 120 then determines a position (e.g., the position 306 of FIG. 3) within an LRU stack (e.g., the LRU stack 300 of FIG. 3) of the cache 110 based on the size of the cache 110 and the fairness index 122(0) for the client 118(0) (block 806). Because the position 306 within the LRU stack 300 directly influences the amount of the cache 110 usable by the client 118(0), the operations of block 806 corresponds to the operations of block 618 of FIG. 6B for allocating the portion 124(0) of the cache 110 based on the fairness index 122(0). The cache allocation circuit 120 allocates a cache line (e.g., the cache line 114(0) of FIG. 1) at the position 306 within the LRU stack 300 of the cache 110 for use by the client 118(0) (block 808). Accordingly, the operations of block 808 may be performed as part of the operations of block 622 of FIG. 6B for writing the data 126 based on the portion 124(0) of the cache 110 allocated to the client 118(0).

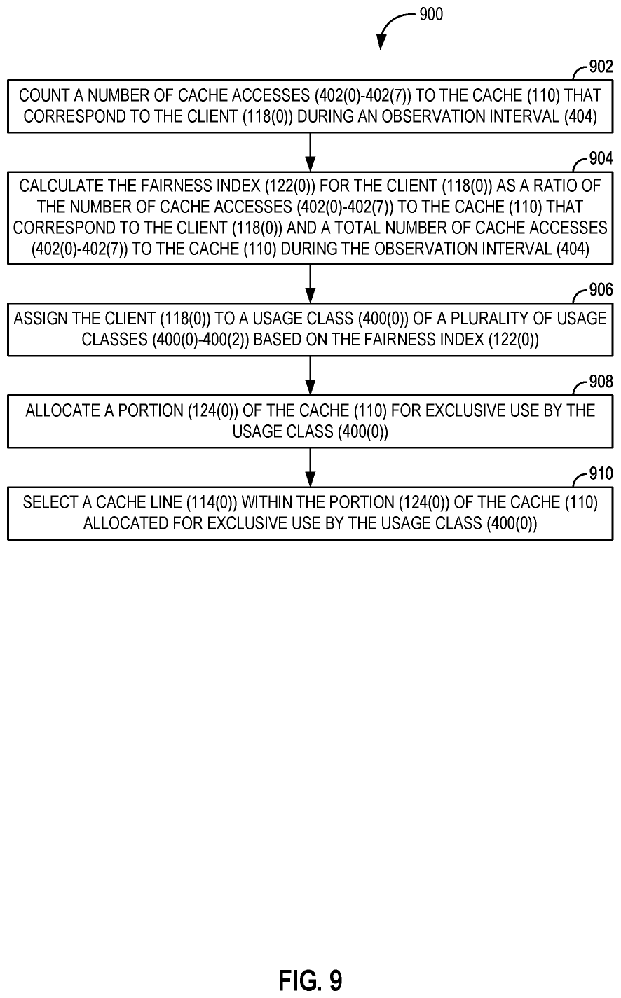

FIG. 9 provides a flowchart illustrating exemplary operations 900 for providing fairness-based allocation of caches by assigning each client of the cache to a usage class and allocating portions of the cache to each usage class based on cache accesses during an observation interval, according to some aspects. For the sake of clarity, elements of FIGS. 1 and 4 are referenced in describing FIG. 9. In FIG. 9, the operations 900 begin with the processor 102 of FIG. 1 (e.g., using the cache allocation circuit 120 of FIG. 1) counting a number of cache accesses, such as the cache accesses 402(0)-402(7) of FIG. 4, to the cache 110 that correspond to a client (e.g., the client 118(0) of FIG. 1) during an observation interval (e.g., the observation interval 404 of FIG. 4) (block 902). The cache allocation circuit then calculates a fairness index (e.g., the fairness index 122(0) of FIG. 1) for the client 118(0) as a ratio of the number of cache accesses 402(0)-402(7) to the cache 110 that correspond to the client 118(0) and a total number of cache accesses 402(0)-402(7) to the cache 110 during the observation interval 404 (block 904). The operations of blocks 902 and 904 thus correspond to the operations of block 602 of FIG. 6A for determining the fairness index 122(0) for the client 118(0).

The cache allocation circuit 120 assigns the client 118(0) to a usage class of a plurality of usage classes (e.g., the usage class 400(0) of the plurality of usage classes 400(0)-400(2) of FIG. 4) based on the fairness index 122(0) (block 906). The cache allocation circuit 120 next allocates a portion (e.g., the portion 124(0) of FIG. 1) of the cache 110 for exclusive use by the usage class 400(0) (block 908). In this manner, the operations of blocks 906 and 908 correspond to the operations of block 618 of FIG. 6B for allocating the portion 124(0) of the cache 110 based on the fairness index 122(0). The cache allocation circuit 120 then selects a cache line (e.g., the cache line 114(0) of FIG. 1) within the portion 124(0) of the cache 110 allocated for exclusive use by the usage class 400(0) (block 910). The operations of block 910 therefore may be performed as part of the operations of block 622 of FIG. 6B for writing the data 126 based on the portion 124(0) of the cache 110 allocated to the client 118(0).

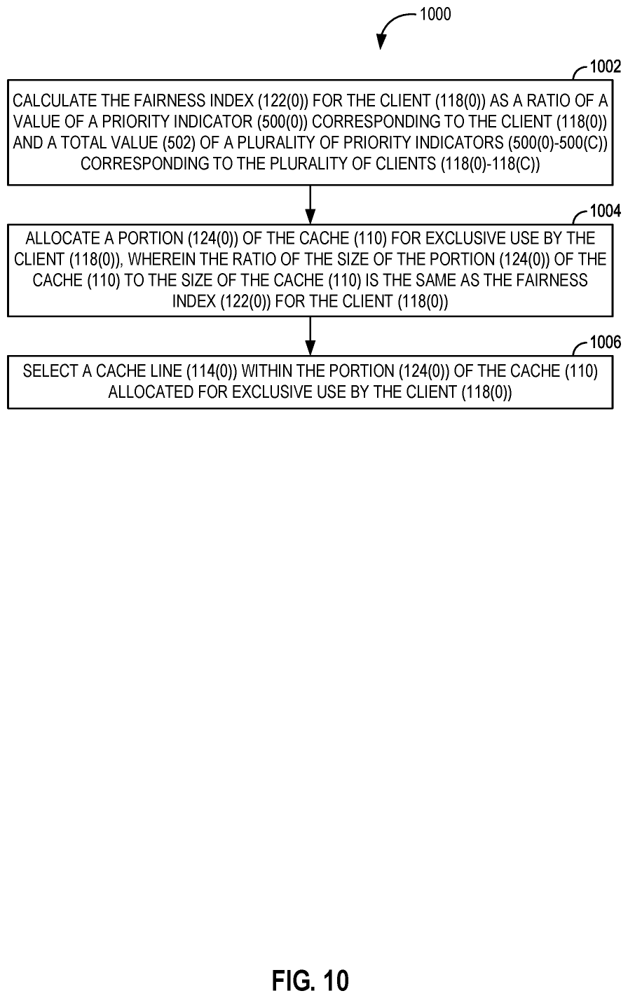

To illustrate operations for providing fairness-based allocation of caches by allocating portions of a cache in proportion to a client priority for each client of the cache relative to a total of client priorities according to some aspects, FIG. 10 provides a flowchart showing exemplary operations 1000. Elements of FIGS. 1 and 5 are referenced in describing FIG. 10 for the sake of clarity. The operations 1000 in FIG. 10 begin with the processor 102 of FIG. 1 (e.g., using the cache allocation circuit 120 of FIG. 1) calculating a fairness index (e.g., the fairness index 122(0) of FIG. 1) for a client (e.g., the client 118(0) of FIG. 1) as a ratio of a value of a priority indicator (e.g., the priority indicator 500(0) of FIG. 5) corresponding to the client 118(0) and a total value (e.g., the value 502 of FIG. 5) of a plurality of priority indicators (e.g., the priority indicators 500(0)-500(C) of FIG. 5) corresponding to the plurality of clients 118(0)-118(C) (block 1002). The operations of blocks 1002 thus correspond to the operations of block 602 of FIG. 6A for determining the fairness index 122(0) for the client 118(0).

The cache allocation circuit 120 then allocates a portion (e.g., the portion 124(0) of FIG. 1) of a cache (e.g., the cache 110 of FIG. 1) for exclusive use by the client 118(0), wherein the ratio of the size of the portion 124(0) of the cache 110 to the size of the cache 110 is the same as the fairness index 122(0) for the client 118(0) (block 1004). In this manner, the operations of block 1004 correspond to the operations of block 618 of FIG. 6B for allocating the portion 124(0) of the cache 110 based on the fairness index 122(0). The cache allocation circuit 120 subsequently selects a cache line (e.g., the cache line 114(0) of FIG. 1) within the portion 124(0) of the cache 110 allocated for exclusive use by the client 118(0) (block 1006). The operations of block 1006 therefore may be performed as part of the operations of block 622 of FIG. 6B for writing the data 126 based on the portion 124(0) of the cache 110 allocated to the client 118(0).

Providing fairness-based allocation of caches in processor-based devices as disclosed in aspects described herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

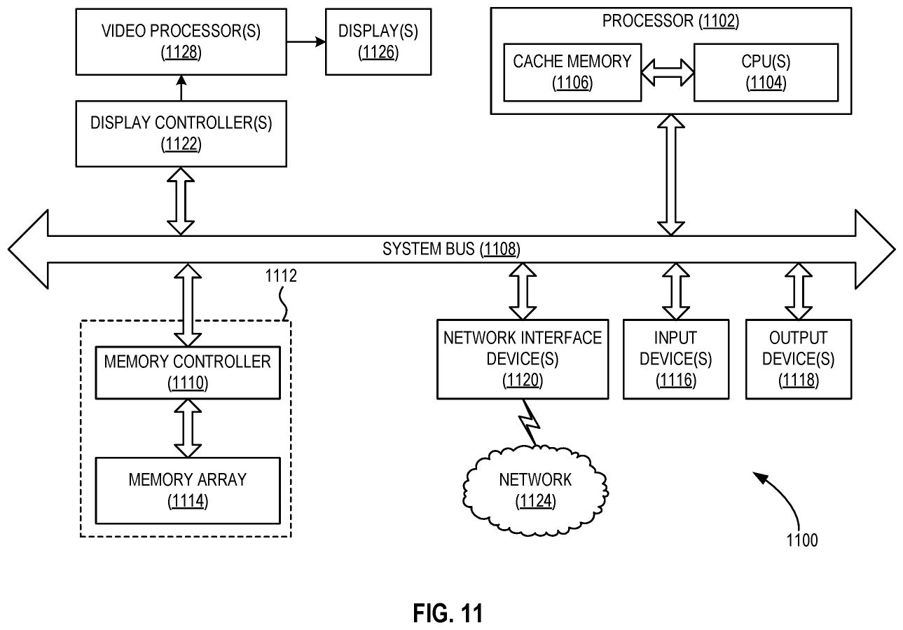

In this regard, FIG. 11 illustrates an example of a processor-based device 1100 that may comprise the processor-based device 100 illustrated in FIG. 1. In this example, the processor-based device 1100 includes a processor 1102 that includes one or more central processing units (captioned as “CPUs” in FIG. 11) 1104, which may also be referred to as CPU cores or processor cores. The processor 1102 may have cache memory 1106 coupled to the processor 1102 for rapid access to temporarily stored data. The processor 1102 is coupled to a system bus 1108 and can intercouple master and slave devices included in the processor-based device 1100. As is well known, the processor 1102 communicates with these other devices by exchanging address, control, and data information over the system bus 1108. For example, the processor 1102 can communicate bus transaction requests to a memory controller 1110, as an example of a slave device. Although not illustrated in FIG. 11, multiple system buses 1108 could be provided, wherein each system bus 1108 constitutes a different fabric.

Other master and slave devices can be connected to the system bus 1108. As illustrated in FIG. 11, these devices can include a memory system 1112 that includes the memory controller 1110 and a memory array(s) 1114, one or more input devices 1116, one or more output devices 1118, one or more network interface devices 1120, and one or more display controllers 1122, as examples. The input device(s) 1116 can include any type of input device, including but not limited to input keys, switches, voice processors, etc. The output device(s) 1118 can include any type of output device, including, but not limited to, audio, video, other visual indicators, etc. The network interface device(s) 1120 can be any device configured to allow exchange of data to and from a network 1124. The network 1124 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 1120 can be configured to support any type of communications protocol desired.

The processor 1102 may also be configured to access the display controller(s) 1122 over the system bus 1108 to control information sent to one or more displays 1126. The display controller(s) 1122 sends information to the display(s) 1126 to be displayed via one or more video processors 1128, which process the information to be displayed into a format suitable for the display(s) 1126. The display controller(s) 1122 and/or the video processors 1128 may be comprise or be integrated into a GPU. The display(s) 1126 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor-based device, comprising:
a processor comprising a cache;
the processor configured to:
   determine a fairness index for a client of a plurality of clients of the cache;
   allocate a portion of the cache for use by the client based on the fairness index;
   receive data to be written to the cache, wherein the data corresponds to the client; and
   write the data to a cache line within the cache based on the portion of the cache allocated to the client.

2. The processor-based device of clause 1, wherein:
the processor is further configured to:
   determine whether the fairness index for the client indicates that reallocation of the cache is necessary; and
   responsive to determining that the fairness index for the client indicates that reallocation of the cache is necessary, increment a reallocation counter; and
the processor is configured to allocate the portion of the cache for use by the client based on the fairness index responsive to determining that the reallocation counter exceeds a reallocation threshold.

3. The processor-based device of any one of clauses 1-2, wherein the cache comprises a Graphics Processing Unit (GPU) cache.

4. The processor-based device of any one of clauses 1-3, wherein:
the cache comprises a Central Processing Unit (CPU) cache; and
the processor is further configured to:
   determine that a new client has started; and
   responsive to determining that the new client has started, initiate reallocation of the cache.

5. The processor-based device of any one of clauses 1-4, wherein:
the cache comprises a read/write cache; and
the processor is further configured to, prior to allocating the portion of the cache for use by the client based on the fairness index:
   identify dirty data in one or more cache lines to be reallocated from the client; and
   flush the dirty data.

6. The processor-based device of any one of clauses 1-5, wherein the processor is configured to determine the fairness index for the client of the plurality of clients by being configured to:
count a number of cache accesses to the cache that correspond to the client during an observation interval; and
calculate the fairness index for the client as a ratio of the number of cache accesses to the cache that correspond to the client and a total number of cache accesses to the cache during the observation interval.

7 The processor-based device of clause 6, wherein the processor is configured to:
allocate the portion of the cache for use by the client based on the fairness index by being configured to allocate a portion of the cache for exclusive use by the client, wherein a ratio of a size of the portion of the cache to a size of the cache is the same as the fairness index for the client; and
write the data to the cache line within the cache based on the portion of the cache allocated to the client by being configured to select a cache line within the portion of the cache allocated for exclusive use by the client.

8. The processor-based device of clause 7, wherein:
the observation interval comprises a driver-configurable time interval; and
the total number of cache access to the cache is based on the driver-configurable time interval and one or more workloads executing on the processor-based device.

9. The processor-based device of any one of clauses 7-8, wherein the processor is further configured to:
count a number of cache hits to the cache that correspond to the client during the observation interval;
calculate a hit ratio for the client as a ratio of the number of cache hits to the cache that correspond to the client and a total number of cache hits to the cache during the observation interval;
determine whether the hit ratio for the client is less than the fairness index for the client;
responsive to determining that the hit ratio for the client is less than the fairness index for the client, decrease the size of the portion of the cache allocated for exclusive use by the client; and
responsive to determining that the hit ratio for the client is not less than the fairness index for the client, increase the size of the portion of the cache allocated for exclusive use by the client.

10. The processor-based device of any one of clauses 6-9, wherein the processor is configured to:
allocate the portion of the cache for use by the client based on the fairness index by being configured to determine a position within a Least Recently Used (LRU) stack of the cache based on the size of the cache and the fairness index for the client; and
write the data to the cache line within the cache based on the portion of the cache allocated to the client by being configured to allocate a cache line at the position within the LRU stack of the cache for use by the client.

11. The processor-based device of any one of clauses 6-10, wherein the processor is configured to:
allocate the portion of the cache for use by the client based on the fairness index by being configured to:
   assign the client to a usage class of a plurality of usage classes based on the fairness index; and
   allocate a portion of the cache for exclusive use by the usage class; and
write the data to the cache line within the cache based on the portion of the cache allocated to the client by being configured to select a cache line within the portion of the cache allocated for exclusive use by the usage class.

12. The processor-based device of any one of clauses 1-11, wherein the processor is configured to:
determine the fairness index for the client of the plurality of clients by being configured to calculate the fairness index for the client as a ratio of a value of a priority indicator corresponding to the client and a total priority value of a plurality of priority indicators corresponding to the plurality of clients;
allocate the portion of the cache for use by the client based on the fairness index by being configured to allocate a portion of the cache for exclusive use by the client, wherein a ratio of a size of the portion of the cache to a size of the cache is the same as the fairness index for the client; and
write the data to the cache line within the cache based on the portion of the cache allocated to the client by being configured to select a cache line within the portion of the cache allocated for exclusive use by the client.

13. The processor-based device of any one of clauses 1-12, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

14. A processor-based device, comprising:
means for determining a fairness index for a client of a plurality of clients of a cache of a processor of the processor-based device;
means for allocating a portion of the cache for use by the client based on the fairness index;
means for receiving data to be written to the cache, wherein the data corresponds to the client; and
means for writing the data to a cache line within the cache based on the portion of the cache allocated to the client.

15. A method, comprising:
determining, using a cache allocation circuit of a processor of a processor-based device, a fairness index for a client of a plurality of clients of a cache of the processor;
allocating a portion of the cache for use by the client based on the fairness index;
receiving data to be written to the cache, wherein the data corresponds to the client; and
writing the data to a cache line within the cache based on the portion of the cache allocated to the client.

16. The method of clause 15, further comprising:
determining whether the fairness index for the client indicates that reallocation of the cache is necessary; and
responsive to determining that the fairness index for the client indicates that reallocation of the cache is necessary, incrementing a reallocation counter;
wherein allocating the portion of the cache for use by the client based on the fairness index is responsive to determining that the reallocation counter exceeds a reallocation threshold.

17. The method of any one of clauses 15-16, wherein the cache comprises a Graphics Processing Unit (GPU) cache.

18. The method of any one of clauses 15-17, wherein:
the cache comprises a Central Processing Unit (CPU) cache; and
the method further comprises:
   determining that a new client has started; and
   responsive to determining that the new client has started, initiating reallocation of the cache.

19. The method of any one of clauses 15-18, wherein:
the cache comprises a read/writing cache; and
the method further comprises, prior to allocating the portion of the cache for use by the client based on the fairness index:
   identifying dirty data in one or more cache lines to be reallocated from the client; and
   flushing the dirty data.

20. The method of any one of clauses 15-19, wherein determining the fairness index for the client of the plurality of clients comprises:
counting a number of cache accesses to the cache that correspond to the client during an observation interval; and
calculating the fairness index for the client as a ratio of the number of cache accesses to the cache that correspond to the client and a total number of cache accesses to the cache during the observation interval.

21. The method of clause 20, wherein:
allocating the portion of the cache for use by the client based on the fairness index comprises allocating a portion of the cache for exclusive use by the client, wherein a ratio of a size of the portion of the cache to a size of the cache is the same as the fairness index for the client; and
writing the data to the cache line within the cache based on the portion of the cache allocated to the client comprises selecting a cache line within the portion of the cache allocated for exclusive use by the client.

22. The method of clause 21, wherein:
the observation interval comprises a driver-configurable time interval; and
the total number of cache access to the cache is based on the driver-configurable time interval and one or more workloads executing on the processor-based device.

23. The method of any one of clauses 21-22, further comprising:
counting a number of cache hits to the cache that correspond to the client during the observation interval;
calculating a hit ratio for the client as a ratio of the number of cache hits to the cache that correspond to the client and a total number of cache hits to the cache during the observation interval;
determining that the hit ratio for the client is less than the fairness index for the client; and
responsive to determining that the hit ratio for the client is less than the fairness index for the client, decreasing the size of the portion of the cache allocated for exclusive use by the client.

24. The method of any one of clauses 20-23, wherein:
allocating the portion of the cache for use by the client based on the fairness index comprises determining a position within a Least Recently Used (LRU) stack of the cache based on a size of the cache and the fairness index for the client; and
writing the data to the cache line within the cache based on the portion of the cache allocated to the client comprises allocating a cache line at the position within the LRU stack of the cache for use by the client.

25. The method of any one of clauses 20-24, wherein:
allocating the portion of the cache for use by the client based on the fairness index comprises:
   assigning the client to a usage class of a plurality of usage classes based on the fairness index; and
   allocating a portion of the cache for exclusive use by the usage class; and
writing the data to the cache line within the cache based on the portion of the cache allocated to the client comprises selecting a cache line within the portion of the cache allocated for exclusive use by the usage class.

26. The method of any one of clauses 15-25, wherein:
determining the fairness index for the client of the plurality of clients comprises calculating the fairness index for the client as a ratio of a value of a priority indicator corresponding to the client and a total priority value of a plurality of priority indicators corresponding to the plurality of clients;
allocating the portion of the cache for use by the client based on the fairness index comprises allocating a portion of the cache for exclusive use by the client, wherein a ratio of a size of the portion of the cache to a size of the cache is the same as the fairness index for the client; and
writing the data to the cache line within the cache based on the portion of the cache allocated to the client comprises selecting a cache line within the portion of the cache allocated for exclusive use by the client.

What is claimed is:

1. A processor-based device, comprising:
a processor comprising a cache;
the processor configured to:
determine a fairness index for a client of a plurality of clients of the cache;
allocate a portion of the cache for use by the client based on the fairness index;
receive data to be written to the cache, wherein the data corresponds to the client; and
write the data to a cache line within the cache based on the portion of the cache allocated to the client.

2. The processor-based device of claim 1, wherein:
the processor is further configured to:
determine whether the fairness index for the client indicates that reallocation of the cache is necessary; and
responsive to determining that the fairness index for the client indicates that reallocation of the cache is necessary, increment a reallocation counter; and
the processor is configured to allocate the portion of the cache for use by the client based on the fairness index responsive to determining that the reallocation counter exceeds a reallocation threshold.

3. The processor-based device of claim 1, wherein the cache comprises a Graphics Processing Unit (GPU) cache.

4. The processor-based device of claim 1, wherein:
the cache comprises a Central Processing Unit (CPU) cache; and
the processor is further configured to:
determine that a new client has started; and
responsive to determining that the new client has started, initiate reallocation of the cache.

5. The processor-based device of claim 1, wherein:
the cache comprises a read/write cache; and
the processor is further configured to, prior to allocating the portion of the cache for use by the client based on the fairness index:
identify dirty data in one or more cache lines to be reallocated from the client; and
flush the dirty data.

6. The processor-based device of claim 1, wherein the processor is configured to determine the fairness index for the client of the plurality of clients by being configured to:
count a number of cache accesses to the cache that correspond to the client during an observation interval; and
calculate the fairness index for the client as a ratio of the number of cache accesses to the cache that correspond to the client and a total number of cache accesses to the cache during the observation interval.

7. The processor-based device of claim 6, wherein the processor is configured to:
allocate the portion of the cache for use by the client based on the fairness index by being configured to allocate a portion of the cache for exclusive use by the client, wherein a ratio of a size of the portion of the cache to a size of the cache is the same as the fairness index for the client; and
write the data to the cache line within the cache based on the portion of the cache allocated to the client by being configured to select a cache line within the portion of the cache allocated for exclusive use by the client.

8. The processor-based device of claim 7, wherein:
the observation interval comprises a driver-configurable time interval; and
the total number of cache access to the cache is based on the driver-configurable time interval and one or more workloads executing on the processor-based device.

9. The processor-based device of claim 7, wherein the processor is further configured to:
count a number of cache hits to the cache that correspond to the client during the observation interval;
calculate a hit ratio for the client as a ratio of the number of cache hits to the cache that correspond to the client and a total number of cache hits to the cache during the observation interval;
determine whether the hit ratio for the client is less than the fairness index for the client;
responsive to determining that the hit ratio for the client is less than the fairness index for the client, decrease the size of the portion of the cache allocated for exclusive use by the client; and
responsive to determining that the hit ratio for the client is not less than the fairness index for the client, increase the size of the portion of the cache allocated for exclusive use by the client.

10. The processor-based device of claim 6, wherein the processor is configured to:
allocate the portion of the cache for use by the client based on the fairness index by being configured to determine a position within a Least Recently Used (LRU) stack of the cache based on the size of the cache and the fairness index for the client; and
write the data to the cache line within the cache based on the portion of the cache allocated to the client by being configured to allocate a cache line at the position within the LRU stack of the cache for use by the client.

11. The processor-based device of claim 6, wherein the processor is configured to:
allocate the portion of the cache for use by the client based on the fairness index by being configured to:
assign the client to a usage class of a plurality of usage classes based on the fairness index; and
allocate a portion of the cache for exclusive use by the usage class; and
write the data to the cache line within the cache based on the portion of the cache allocated to the client by being configured to select a cache line within the portion of the cache allocated for exclusive use by the usage class.

12. The processor-based device of claim 1, wherein the processor is configured to:
determine the fairness index for the client of the plurality of clients by being configured to calculate the fairness index for the client as a ratio of a value of a priority indicator corresponding to the client and a total priority value of a plurality of priority indicators corresponding to the plurality of clients;
allocate the portion of the cache for use by the client based on the fairness index by being configured to allocate a portion of the cache for exclusive use by the client, wherein a ratio of a size of the portion of the cache to a size of the cache is the same as the fairness index for the client; and
write the data to the cache line within the cache based on the portion of the cache allocated to the client by being configured to select a cache line within the portion of the cache allocated for exclusive use by the client.

13. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

14. A processor-based device, comprising:
means for determining a fairness index for a client of a plurality of clients of a cache of a processor of the processor-based device;
means for allocating a portion of the cache for use by the client based on the fairness index;
means for receiving data to be written to the cache, wherein the data corresponds to the client; and
means for writing the data to a cache line within the cache based on the portion of the cache allocated to the client.

15. A method, comprising:
determining, using a cache allocation circuit of a processor of a processor-based device, a fairness index for a client of a plurality of clients of a cache of the processor;
allocating a portion of the cache for use by the client based on the fairness index;
receiving data to be written to the cache, wherein the data corresponds to the client; and
writing the data to a cache line within the cache based on the portion of the cache allocated to the client.

16. The method of claim 15, further comprising:
determining whether the fairness index for the client indicates that reallocation of the cache is necessary; and
responsive to determining that the fairness index for the client indicates that reallocation of the cache is necessary, incrementing a reallocation counter;
wherein allocating the portion of the cache for use by the client based on the fairness index is responsive to determining that the reallocation counter exceeds a reallocation threshold.

17. The method of claim 15, wherein the cache comprises a Graphics Processing Unit (GPU) cache.

18. The method of claim 15, wherein:
the cache comprises a Central Processing Unit (CPU) cache; and
the method further comprises:
determining that a new client has started; and
responsive to determining that the new client has started, initiating reallocation of the cache.

19. The method of claim 15, wherein:
the cache comprises a read/writing cache; and
the method further comprises, prior to allocating the portion of the cache for use by the client based on the fairness index:
identifying dirty data in one or more cache lines to be reallocated from the client; and
flushing the dirty data.

20. The method of claim 15, wherein determining the fairness index for the client of the plurality of clients comprises:
counting a number of cache accesses to the cache that correspond to the client during an observation interval; and
calculating the fairness index for the client as a ratio of the number of cache accesses to the cache that correspond to the client and a total number of cache accesses to the cache during the observation interval.

21. The method of claim 20, wherein:
allocating the portion of the cache for use by the client based on the fairness index comprises allocating a portion of the cache for exclusive use by the client, wherein a ratio of a size of the portion of the cache to a size of the cache is the same as the fairness index for the client; and
writing the data to the cache line within the cache based on the portion of the cache allocated to the client comprises selecting a cache line within the portion of the cache allocated for exclusive use by the client.

22. The method of claim 21, wherein:
the observation interval comprises a driver-configurable time interval; and
the total number of cache access to the cache is based on the driver-configurable time interval and one or more workloads executing on the processor-based device.

23. The method of claim 21, further comprising:
counting a number of cache hits to the cache that correspond to the client during the observation interval;
calculating a hit ratio for the client as a ratio of the number of cache hits to the cache that correspond to the client and a total number of cache hits to the cache during the observation interval;
determining that the hit ratio for the client is less than the fairness index for the client; and
responsive to determining that the hit ratio for the client is less than the fairness index for the client, decreasing the size of the portion of the cache allocated for exclusive use by the client.

24. The method of claim 20, wherein:
allocating the portion of the cache for use by the client based on the fairness index comprises determining a position within a Least Recently Used (LRU) stack of the cache based on a size of the cache and the fairness index for the client; and
writing the data to the cache line within the cache based on the portion of the cache allocated to the client comprises allocating a cache line at the position within the LRU stack of the cache for use by the client.

25. The method of claim 20, wherein:
allocating the portion of the cache for use by the client based on the fairness index comprises:
assigning the client to a usage class of a plurality of usage classes based on the fairness index; and
allocating a portion of the cache for exclusive use by the usage class; and
writing the data to the cache line within the cache based on the portion of the cache allocated to the client comprises selecting a cache line within the portion of the cache allocated for exclusive use by the usage class.

26. The method of claim 15, wherein:
determining the fairness index for the client of the plurality of clients comprises calculating the fairness index for the client as a ratio of a value of a priority indicator corresponding to the client and a total priority value of a plurality of priority indicators corresponding to the plurality of clients;
allocating the portion of the cache for use by the client based on the fairness index comprises allocating a portion of the cache for exclusive use by the client, wherein a ratio of a size of the portion of the cache to a size of the cache is the same as the fairness index for the client; and
writing the data to the cache line within the cache based on the portion of the cache allocated to the client comprises selecting a cache line within the portion of the cache allocated for exclusive use by the client.
